(19) United States
(12) Patent Application Publication
(10) Pub. No.: US 2015/0165957 A1
(43) Pub. Date: Jun. 18, 2015

(54) LOAD CARRYING DUMP BODY FOR A MACHINE

(71) Applicant: Caterpillar Inc., Peoria, IL (US)

(72) Inventors: Gowdhaman Sarangapani, Chennai (IN); Mohan R. Venu, Chennai (IN); Mathankumar Gunasekaran, Chennai (IN)

(73) Assignee: Caterpillar Inc., Peoria, IL (US)

(21) Appl. No.: 14/633,150

(22) Filed: Feb. 27, 2015

(51) Int. Cl. B60P 1/28

(52) U.S. Cl. CPC B60P 1/286

(57) ABSTRACT

A dump body, with a floor panel assembly, a first sidewall, a second sidewall, a front wall panel assembly, and a canopy panel is disclosed. The floor panel assembly is equipped with a first frame assembly which includes a pair of spaced rails and a plurality of cross members. The pair of spaced rails overlay the plurality of cross members and is generally perpendicularly positioned relative to the pair of spaced rails. The front wall panel assembly includes a second frame assembly having a pair of spaced rails and at least one cross member being in a generally perpendicular overlay position relative to the pair of spaced rails. The canopy panel extends outwards from the front wall panel assembly and is attached to a top edge portion of the front wall panel assembly.

### TECHNICAL FIELD

The present disclosure generally relates to load carrying dump bodies for machines. More particularly, the present disclosure relates to a reinforced dump body using curved panels for carrying structure and decreasing the use of heavy frame members to optimize dump body design.

### BACKGROUND

Machines, such as off-highway trucks, may be used to carry payload to a dumpsite. The amount of the payload that may be hauled in such machines is often limited by a maximum gross vehicular weight. The maximum gross vehicular weight is a limit established by factors, such as a power-train and a weight that can be carried by wheels. Moreover, for applications in rough terrains and harsh environments larger and more robust systems are often required which increases the weight of the machines. For this purpose, the machines may be designed and manufactured from metals for durability and robustness. This generally results in heavier machines. A reduction in machine weight may allow an operator to increase the payload by the same amount without exceeding the maximum gross vehicular weight. An increase in payload may translate to an increase in productivity, which results in higher profits. Further, a reduction of the weight of the machine lowers fuel consumption. In order to maximize the machine's productivity, it is desirable to minimize the machine's weight to maximize the weight of the payload that may be safely carried or transported by the truck.

One method to reduce the weight of the machine is to reduce the size and number of heavier, metal components on a machine. For example, a dump body on the machine may be manufactured by using metal plates with a lower minimum thickness required to support the payload. However, as the amount of metal utilized in the machine is decreased, the durability and life of certain portions of the machine may be affected. For example, the use of thin metal in the payload container may cause the metal to sag, deform, and wear out quickly. It is also known to reduce weight of the machine by having the dump body that is made of curved bed portions. This increases rigidity and lessens the need for heavier frame structures. However, these contoured beds require special curved sections and are expensive to manufacture.

U.S. Pat. No. 6,520,590 discloses a truck bed for a mining dump truck. A bottom surface of the bed hopper has a plurality of externally positioned transverse beams along a curved bottom or floor of the truck. The bottom and the frame supporting the same may provide the proper support to carry the intended loads however it is expensive to invest in the tooling needed for such truck bed especially if the bed is manufactured at more than one site. Moreover, the costs associated with manufacturing this truck bed are high and such a bed may not be easy to manufacture using traditional materials and techniques throughout manufacturing facilities worldwide.

The present disclosure seeks to address one or more of the problems associated with known truck beds or dump bodies.

### SUMMARY OF THE INVENTION

Various aspects of the present disclosure disclose a dump body for a machine. The dump body includes a floor panel assembly, a first sidewall, a second sidewall, a front wall panel assembly, and a canopy panel. The floor panel assembly includes a bottom plate member, a first curved panel member and a second curved panel member. The floor panel assembly is equipped with a first frame assembly which includes a pair of spaced rails and multiple cross members. The pair of spaced rails overlay the multiple cross members and is generally perpendicularly positioned relative to the pair of spaced rails. The first frame assembly is attachable to the bottom plate member is completely enclosed within the bottom plate member. The first sidewall is attached to the first curved panel member and the second sidewall is attached to the second curved panel member. The first sidewall and the second sidewall extend outwardly from the bottom plate member. The front wall panel assembly includes a front plate member, a first curved corner member, and a second curved corner member. The front plate member is integrally attached to the first curved corner member and the second curved corner member. The first curved corner member includes a first edge which is attached to the first curved panel member of the floor panel assembly. The second curved corner member has a second edge being attached to the second curved panel member of the floor panel assembly. The front wall panel assembly includes a second frame assembly having a pair of spaced rails and at least one cross member being in generally perpendicular overlay position relative to the pair of spaced rails. The second frame assembly of the front wall panel assembly is attachable to the front plate member and is completely enclosed within the front plate member. The canopy panel extends outwards from the front wall panel assembly and is attached to a top edge portion of the front wall panel assembly.

### BRIEF DESCRIPTION OF THE DRAWINGS

FIG. 1 is a perspective view of an exterior, underside of a dump body illustrating the floor panel assembly, a first side and a front wall of the dump body, in accordance with the concepts of the present disclosure;

FIG. 2 is a perspective view of the dump body of FIG. 1 illustrating a second side of the dump body, a floor panel assembly and the front wall of the dump body, in accordance with the concepts of the present disclosure; and

FIG. 3 is a perspective view of the dump body shown of FIG. 1, illustrating the front wall and the first side and the floor panel assembly thereof, in accordance with the concepts of the present disclosure.

### DETAILED DESCRIPTION

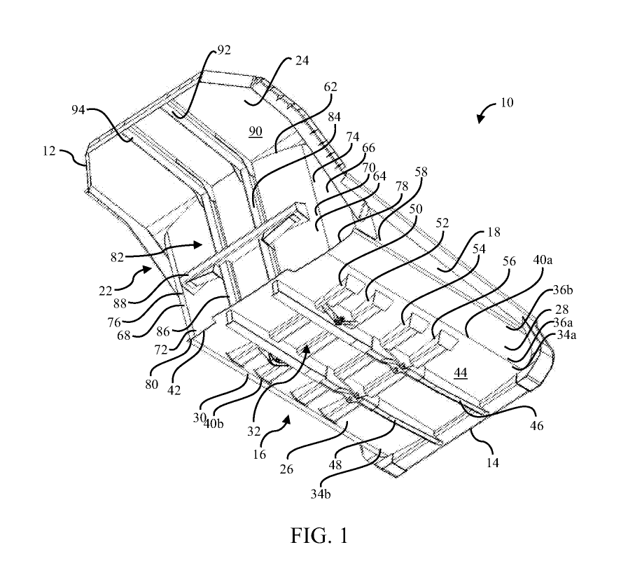

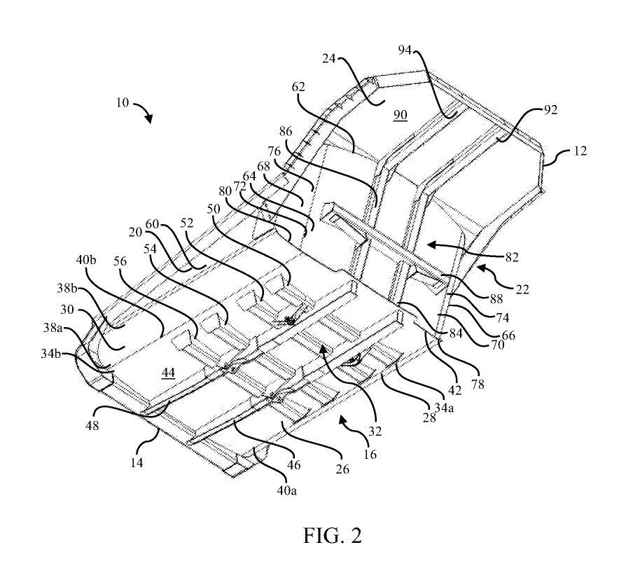

Referring to FIG. 1, there is shown a dump body 10 which shows a first side. Description for FIG. 1 is equally applicable to FIG. 2, which shows a second side of the dump body 10. The dump body 10 may be attached to and supported by a frame of a machine (not shown). The machine (not shown) may be an off-highway vehicle, dump truck, or/and a mining truck. The dump body 10 extends between a front end 12 and a rear end 14 of the dump body 10. The dump body 10 includes a floor panel assembly 16, a first sidewall 18, a second sidewall 20 (shown in FIG. 2), a front wall panel assembly 22, and a canopy panel 24.

The floor panel assembly 16 includes a bottom plate member 26, a first curved panel member 28, a second curved panel member 30 (FIG. 2), and a first frame assembly 32. The bottom plate member 26 includes a first lateral side 34a and a second lateral side 34b. The first curved panel member 28 includes a first edge 36a and a second edge 36b. Similarly, the second curved panel member 30 includes a first edge 38a and a second edge 38b. The first lateral side 34a of the bottom plate member 26 is attached with the first edge 36a of the first curved panel member 28, to form a continuous and uninterrupted joint 40a, through welding. Similarly, FIG. 2 shows the second lateral side 34b of the bottom plate member 26 attached with the first edge 38a of the second curved panel member 30, to form a continuous and uninterrupted joint 40b.

In addition, the bottom plate member 26 includes a first end 42, which is proximal to the front end 12 of the dump body 10. The bottom plate member 26 includes a first surface (not shown) and a second surface 44. The first surface (not shown) supports a load. The second surface 44 of the bottom plate member 26 is provided with the first frame assembly 32. The bottom plate member 26 may be manufactured from a flat plate. The first frame assembly 32 is attached onto the second surface 44 of the bottom plate member 26 such that the first frame assembly 32 is completely enclosed in an area of the flat plate, that is, the bottom plate member 26.

The first frame assembly 32 includes two spaced rails 46, 48 and four cross members 50, 52, 54, 56. The spaced rails 46, 48 are oriented along a direction of the first curved panel member 28 and the second curved panel member 30. Length of the spaced rails 46, 48 may be equal to or lesser than length of the bottom plate member 26. The cross members 50, 52, 54, 56 are oriented in a direction, perpendicular to the spaced rails 46, 48. The cross members 50, 52, 54, 56 have a length equal to or lesser than a width of the bottom plate member 26. The cross members 50, 52, 54, 56 overlay the spaced rails 46, 48, so as to form an interlacing grid support structure, such that the interlacing grid support structure, is completely enclosed in an area of the bottom plate member 26.

The floor panel assembly 16 is further attached to the first sidewall 18 and the second sidewall 20. The first sidewall 18 is structured and arranged opposite to the second sidewall 20. The first sidewall 18 and the second sidewall 20, respectively, include a first sidewall lateral edge 58 and a second sidewall lateral edge 60. The first sidewall lateral edge 58 is attached to the second edge 36b of the first curved panel member 28, to facilitate attachment of the floor panel assembly 16 with the first sidewall 18. The attachment is such that the first sidewall 18 extends outwardly longitudinally from the bottom plate member 26. Similarly, FIG. 2 shows the second sidewall lateral edge 60 being attached to the second edge 38b of the second curved panel member 30. This results in attachment of the floor panel assembly 16 with the second sidewall 20. The attachment is such that the second sidewall 20 extends outward longitudinally from the bottom plate member 26. The first sidewall 18 and the second sidewall 20 along with the bottom plate member 26, form a closed-volume structure to receive and carry a payload.

The floor panel assembly 16 is attached to the front wall panel assembly 22. The front wall panel assembly 22 may be located behind an operator cab of the machine (not shown). The front wall panel assembly 22 supports a significant portion of the load or weight of a load within the dump body 10. The front wall panel assembly 22 includes a top edge portion 62, a front plate member 64, a first curved corner member 66, and a second curved corner member 68. The top edge portion 62 is a top periphery portion, which is distant from the floor panel assembly 16. The front plate member 64 may be manufactured from a flat plate. The front plate member 64 is attached to the first end 42 of the bottom plate member 26. The front plate member 64 includes a first lateral edge 70 and a second lateral edge 72. The first curved corner member 66 and the second curved corner member 68, respectively, include a first edge 74 and a second edge 76. The first lateral edge 70 of the front plate member 64 is integrally attached to the first edge 74 of the first curved corner member 66. Similarly, the second lateral edge 72 of the front plate member 64 is integrally attached to the second edge 76 of the second curved corner member 68. The first curved corner member 66 includes a first corner edge 78, via which the first curved corner member 66 is attached to the first curved panel member 28. Similarly, the second curved corner member 68 includes a second corner edge 80, via which the second curved corner member 68 is attached to the second curved panel member 30.

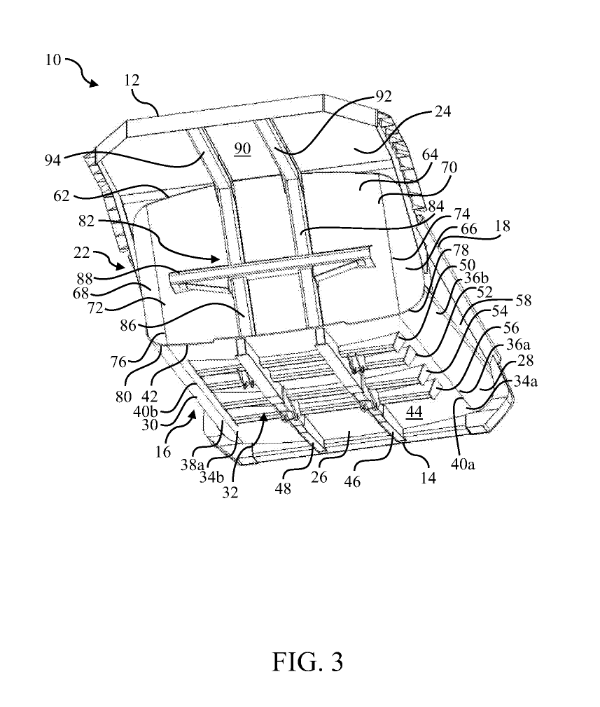

In addition, the front wall panel assembly 22 is provided with a second frame assembly 82. As best seen in FIG. 3, a front view of the dump body 10 shows the front wall panel assembly 22, fully enclosing the second frame assembly 82. The second frame assembly 82 includes two spaced rails 84, 86 and one cross member 88. The spaced rails 84, 86 are attached to the front plate member 64, in a direction parallel to the first curved corner member 66 and the second curved corner member 68. Length of the spaced rails 84, 86 is equal to a length of the front plate member 64. It may be contemplated that the length of the spaced rails 84, 86 may be lesser than the length of the front plate member 64. The cross member 88 is attached to the front plate member 64, in a way such that the cross member 88 is generally perpendicular to the two spaced rails 84, 86. The cross member 88 with a length lesser than a width of the front plate member 64, overlays the spaced rails 84, 86, so as to form the interlacing grid support structure. The second frame assembly 82 is attached onto the front plate member 64, such that the second frame assembly 82 is completely enclosed in an area of the flat plate, that is, the front plate member 64.

The front wall panel assembly 22 is attached to the canopy panel 24. The canopy panel 24 is attached to the top edge portion 62 of the front wall panel assembly 22. The canopy panel 24 extends outwardly in a horizontal direction, from the top edge portion 62 of the front wall panel assembly 22 over the operator cab (not shown). The canopy panel 24 may have a horizontal orientation which is nearly parallel to the bottom plate member 26. The canopy panel 24 includes a canopy surface 90, which is proximal to the operator cab (not shown). The canopy panel 24 provides protection to the operator cab (not shown) from earth, debris, and other material that may be dumped into the dump body 10, and on the canopy panel 24. Further, the canopy panel 24 includes two longitudinal beams 92, 94 which are attached to the canopy surface 90. The two longitudinal beams 92, 94 are attached to the canopy surface 90 in a direction parallel of a length of the canopy panel 24. The two longitudinal beams 92, 94 extends outwardly from the top edge portion 62 along the length of the canopy panel 24. Length of the longitudinal beams 92, 94 is equal to a length of the canopy panel 24. It may be contemplated that the length of the longitudinal beams 92, 94 is lesser than the length of the canopy panel 24.

### INDUSTRIAL APPLICABILITY

In operation, the dump body 10 is loaded by an operator for various operations. The payload carried by the dump body 10 exerts forces on the floor panel assembly 16 and the front wall panel assembly 22 of the dump body 10. For this purpose, the dump body 10 is provided with the first frame assembly 32 attached and completely enclosed in the bottom plate member 26 and the second frame assembly 82 attached and completely enclosed in the front plate member 64. The frame assemblies 32, 82 provide support to the dump body 10. This configuration may strengthen the floor panel assembly 16 and the front wall panel assembly 22, and enable thinner panels to carry additional weight without increased deformation. The distance between individual, adjacent spaced rails 46, 48, 84, 86 and individual, adjacent cross members 50, 52, 54, 56, 68 may be determined to properly support predicted loads on the floor panel assembly 16 and the front wall panel assembly 22 of the dump body 10. The forces against the canopy panel 24 and the front wall panel assembly 22 are generally less than forces against the floor panel assembly 16. The canopy panel 24, which is least subjected to forces, has only two longitudinal beams 92, 94.

The disclosed dump body 10 is made of selective curved members to provide a strong and robust structure. This minimizes requirement of many and heavy frame members for supporting the dump body 10. Hence, the disclosed dump body 10 is structured in a way so as to minimize spaced rails and cross members, in number. Minimization of the number of spaced rails and cross members results in a light-weight dump body 10. This makes manufacturing of the dump body 10 an easy and less expensive process, as alight-weight dump body 10 reduces weld process, manufacturing time and cost. Also, the curved body design of the disclosed dump body 10 will improve the machine performance by a reduction in fuel consumption, repair and maintenance cost. In addition, the curved floor panel assembly 16 will improve the material flow during unloading of the load.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. Therefore, it is not desired to limit the disclosure to the exact construction and operation illustrated and described, and, accordingly, all suitable modifications and equivalents may be resorted to that fall within the scope of the disclosure.

What is claimed is:

1. A dump body for a machine comprising:
a floor panel assembly including a bottom plate member, a first curved panel member and a second curved panel member, the floor panel assembly including a first frame assembly having a pair of spaced rails and a plurality of cross members being in a generally perpendicular overlay position relative to the pair of spaced rails, wherein the first frame assembly being attachable to the bottom plate member and the first frame assembly being completely enclosed within the bottom plate member;
a first sidewall and a second sidewall, the first sidewall attached to the first curved panel member and the second sidewall attached to the second curved panel member, wherein the first sidewall and the second sidewall extending outwardly from the bottom plate member;
a front wall panel assembly including a front plate member, a first curved corner member and a second curved corner member, the front plate member is integrally attached to the first curved corner member and the second curved corner member, the first curved corner member having a first edge being attached to the first curved panel member of the floor panel assembly, the second curved corner member having a second edge being attached to the second curved panel member of the floor panel assembly, the front wall panel assembly including a second frame assembly having a pair of spaced rails and at least one cross member being in a generally perpendicular overlay position relative to the pair of spaced rails, wherein the second frame assembly of the front wall panel assembly being attachable to the front plate member and the second frame assembly being completely enclosed within the front plate member; and
a canopy panel being attached to a top edge portion of the front wall panel assembly and outwardly extending therefrom.
